(19) United States
(12) Patent Application Publication
(10) Pub. No.: US 2008/0027744 A1
(43) Pub. Date: Jan. 31, 2008

(54) METHOD FOR OPTIMIZATION OF BRA FIT AND STYLE FOR ALL BODY SIZES AND TYPES AND FOR WEARING WITH A VARIETY OF CLOTHING STYLES

(76) Inventor: Susan Nethero, Roswell, GA (US)

Correspondence Address: Seth H. Ostrow, Esq.;DREIER LLP, 12th Floor, 499 Park Avenue, New York, NY, 10022, US

(21) Appl. No.: 11/829,568

(22) Filed: Jul. 27, 2007

Related U.S. Application Data
(60) Provisional application No. 60/820,544, filed on Jul. 27, 2006.

(51) Int. Cl. G06Q 30/00

(52) U.S. Cl. 705/1

(57) ABSTRACT

A method for custom bra fitting to obtain optimal physical fit and optimal style including selecting bras for a woman based on an analysis of the size and shape of her body and breasts and determining the six fitting tips, or style tips, of youthful, uplift, coverage, proportionate, centered, and definition. A further aspect of this invention includes selecting bras to round out a women's bra wardrobe by supplementing her wardrobe with various bra styles including T-Shirt, plunge, classic lace, sexy date and convertible bras. A further aspect of this invention includes selecting a variety of bra shapes including demi, semi-demi, balcony and full to complete a woman's bra wardrobe. A further aspect of the custom bra fitting includes consideration of information contained in a questionnaire completed by the woman. A further aspect of this invention includes designing bras that implement the six style tips.

### PRIORITY APPLICATION

The present application claims priority from commonly owned provisional U.S. patent application Ser. No. 60/820,544, entitled METHOD FOR OPTIMIZATION OF BRA FIT AND STYLE FOR MULTIPLE BODY SIZES AND TYPES, AND FOR WEARING WITH A VARIETY OF OUTER GARMENTS.

### COPYRIGHT NOTICE

A portion of the disclosure of this patent document contains material subject to copyright protection. The copyright owner has no objection to the facsimile reproduction by anyone of the patent document or the patent disclosure as it appears in the Patent and Trademark Office patent files or records, but otherwise reserves all copyright rights whatsoever.

### FIELD OF THE INVENTION

The present invention relates generally to custom bra fitting methods and, more particularly, to techniques and methods to provide women with a custom bra fitting to achieve not only optimal physical fit, but also optimal style.

### BACKGROUND OF THE INVENTION

Fashion choices in clothing and apparel styles have assumed greater importance for women than ever and, as such, there is a growing need for custom selection, fit and style. Optimal fit and style is desired not only in women's clothing, but also in the undergarments that can provide women with a figure and shape that make them look better and slimmer in their clothing.

The success of retail chains specializing in women's undergarments and intimate apparel demonstrates that undergarments are an important component of a women's wardrobe. However, retail chains and department stores tend to offer limited selection and minimal services in the context of custom bra fittings. For the last three decades, these retailers have not focused on bra fit and have provided no style guidance for the individual consumer. Indeed, most mass marketers have narrowed bra size and style selection to the most popular sizes. As a result, most women have never had optimal fit and optimal style from their bra wardrobe. In fact, studies have shown that up to 90% of women are wearing the wrong bra size. This equates to approximately 80 million women over the age of 18 in the United States.

Not only have many specialty stores gone out of business in favor of the non-service oriented mass marketer and department stores, but these mass marketers use price promotions and other promotional tactics that further encourage customers to seek discount deals rather than optimal fit and style. Today, there are fewer than 500 fitting specialty stores in the United States.

To the extent that any customized bra fitting occurs in retail chains and department stores, the consumer can only choose from the closest size and selection from an existing, limited product line. Such fitting services are thus directed solely at the bottom line goal of selling a garment from the product line.

Further, the traditional bra fitting measurement techniques that are practiced by department stores, mass marketers, or retail chains are highly inaccurate. The traditional measurement techniques typically involve the use of a tape measure. After fifteen years of experience fitting thousands of women, it is the expert opinion of applicant that tape measures are not accurate over 50% of the time. Standard industry measurement is often conducted by inexperienced staff who do not consistently measure the correct places on the body and reportedly measure over clothing and/or over an existing bra. Bra band measurements are also often taken too high on the torso to get a proper measurement and bra size. Bra cup size measurements with a tape measure do not address breast volume or degree of firmness. As a result, more than half of all measurements based solely on a tape measure fitting are wrong or misleading.

A tape measure is a rigid measuring tool and cannot simulate how a bra functions with stretch materials. While a tape measure can provide numeric distance around the body, it cannot provide any information regarding distribution of the breasts on the torso. It may provide a measured distance, which is seemingly quantifiable. However, the landscape can be radically different. For instance, two women can measure the same size, but distribute very differently due to breast shape, firmness, and horizontal and vertical position on the body. Also, if a woman has experienced augmentation, her tissue and distribution can be of a different and wider form. To further illustrate this point, the appendix includes drawings that illustrate how different shapes are possible within the same size. For additional information concerning the inadequacies of tape measurement, the appendix includes a poster entitled, “Tape Measures Don't Tell the Whole Story.”

Many women also may cling to an “ideal” size, or one they once were, without realizing that their breast size will change many times over the course of their life as they age and move from one stage of life to the next. An individual woman's breast size, and corresponding bra size, may change six to nine times as women experience changes from pregnancy, childbirth, breasffeeding, menopause, weight gain and weight loss.

Women often misunderstand cup sizing standards. They believe that all B, C or D cups are the same regardless of the back size or band width. In fact, each time the bra band width increases in the same cup size, the cup size allows for approximately one additional inch of volume per breast. In other words, a 34B cup is one inch smaller in volume for each breast than a 36B cup, irrespective of the larger band. This confusion causes women to stay in the same cup and go up in back size, or band width, never realizing they are getting a deeper cup as they transition throughout life from a 34B to 36B to 38B. They wonder why the cup is not fitting any longer and they get further frustrated thinking their breasts have lost volume and firmness, which may or may not be true.

As a woman's body changes, proper bra fit is crucial to providing the proper support for breasts. Without proper support, breasts will sag over time. Breasts are composed of adipose tissue (fat), blood vessels, lymph glands, collagen fibers, capillaries and skin. Without adequate support, a breast will hang and the tiny ligaments and blood vessels in the breast will stretch from the weight of the tissue. Breast stress occurs and the breasts will begin to sag and droop. When the breasts sag, breast strain occurs and proper bloodflow to the breasts will be blocked. The delicate breast tissue will start to roll off the chest wall, over the pectoral muscle, and move into the arm and midriff area. The breast tissue under the arm will be bumped and battered with every move. A pendulous look will begin to develop. The appendix includes a breast sagging diagram for further illustration of this point.

At the point of breast damage especially, breast weight can pull on the neck, causing stress and diminished blood flow to the head and thereby cause headaches. Further, weight and gravity combine to affect body posture. At this stage, many women try to lift the breast weight off their rib cage by shortening bra straps. This just magnifies the problems as the bra band will ride up the back and the straps will dig into and create painful grooves in the shoulders.

Unfortunately, most women blame their own bodies for the bra fit problems they have. Women tend to take more blame for the shape and figure they have grown into, rather than appropriately placing the blame on the traditional fitting techniques and bras themselves. Bras are the most personal product a woman buys and also the most technical product she wears. As a consequence, many women feel their bra problems cannot be solved and live with a feeling of defeat believing that there are not any satisfactory answers to their problem.

Another problem with the retail chain store's traditional fitting methods is that the clerks do not give undivided attention to the women needing assistance and no trust can develop from a one-on-one relationship that results from a truly customized bra fitting appointment. Further, most department stores rely on the bra manufacturers to provide “fit events” and do not have resident fit professionals available for the customer during hours of operation because it is more cost effective to require manufacturers to provide this specialized service. When stores do make clerks available for a fitting service, a single clerk often assists multiple customers at the same time or a series of clerks assist one customer throughout the shopping and sizing experience. Understandably, many women may be embarrassed and hesitant to seek professional help and custom fittings under these circumstances because trying on bras and exposing breasts to another is quite personal.

Current new and existing techniques have attempted to computerize and automate the fitting service to eliminate the embarrassment and the need for a human fitter. However, these computerized systems leave the woman to input her own measurements and trust a computer to provide bras that will fit and meet her bra needs. This technology will not improve fit but will further exacerbate the problems most women have. It is also recognized that the existing computerized systems merely perpetuate the existing problems with fitting techniques because these systems perform computations and bra-selection operations in response to the above-described faulty tape-measurement techniques.

Furthermore, these computerized systems and the traditional measurement services attempt to provide only a tangible benefit, overlooking the psychological benefits of improved self-image, self-confidence, as well as the flattering shape and fashionable styles needed for a woman's casual, career, and social life.

Not only do many women unnecessarily suffer from a sense of defeat in trying to locate the perfect bra for their body, many women live with physical discomfort from the bras they wear as a result of traditional measurement techniques. For instance, many women suffer unnecessary shoulder stiffness and pain caused by mistakenly relying on the straps for support. Many women also avoid underwire bras for comfort because they believe them to be harsh and uncomfortable.

In attempt to fix the pain caused by ill-fitting bras, many women worsen their bra fit problem by trying to achieve comfort. In a quest for comfort, many women will buy a bra that is too big around and then when they wear it for several weeks, it stretches and leaves them with a sloppy appearance. Women commonly associate looseness with comfort not realizing that a firm fitting bra, which supports and lifts for 16 to 18 hours a day, must be stable on the body. If a bra is too large, the back will ride up, the straps will fall down, and the underwire will cause the weight of the breasts to rest on the rib cage. This will result in red marks and discomfort after hours of wear. On that note, many women also complain that they have a big back and suffer from a back fat problem that is especially noticeable when wearing a bra. Erroneously, many of these women buy larger bras thinking that the back fat results from a tight bra.

In addition, many large-chested women wear breast minimizers that deceive them into feeling like they have reduced their size. Compression-based minimizers flatten a woman's breast against her torso and spread the breast tissue under her arm and down her chest wall cavity. While she may feel smaller, when she looks down the front of her body, she does not see that she spreads wide and low. This makes her appear thick and eliminates any hope of a shapely figure or waistline. These breast compressors also cause women to lose breast firmness and do not provide the required support.

Many women have also been traumatized by a strapless bra failure and will never trust strapless bras again. Many larger-breasted women especially believe that they have to be small-breasted to wear strapless bras and thereby they forego strapless dresses. On a similar note, large-breasted women often mistake contour bras for padded bras and conclude that they are too full busted to wear these. These women never realize the benefit of a contour bra. Contour bras provide shape for the soft tissue in the breast and provide breast definition for large and small busted women. Contour bras also minimize embarrassing nipple show-through.

Another problem that results from traditional measurement techniques is waste. Many bras languish in lingerie drawers and money is wasted on bras that are never worn. For instance, a recent survey of approximately 1,500 women asking women how many bras they own shows that approximately 31% of women own one to five bras, approximately 29% of women own five to eight bras, approximately 20% of women own eight to twelve bras, approximately 6% of women own twelve to sixteen bras, and approximately 7% of women own more than sixteen bras. (Approximately 7% of women did not answer the question).

Yet, when the women were asked how many of the bras in their wardrobe they wear, the survey shows that approximately 23% of women wear fewer than two bras, approximately 45% of women wear three to four bras, approximately 15% of women wear five to seven bras, and approximately 6% of women wear eight or more bras. (Approximately 12% of women did not answer the question). These numbers show that women do not wear many of the bras in their wardrobe and that approximately 67% of women wear fewer than four bras regularly.

Further, the survey results asked women directly what percent of the bras in their wardrobe they do not wear. Approximately 24% of women indicated that they do not wear 20% of their bras. Approximately 20% of women indicated that they do not wear 40% of their bras. Approximately 19% of women indicated that they do not wear 60% of their bras. Approximately 10% of women indicated that they do not wear 80% of their bras. (Approximately 28% of women did not answer the question). What women need is a wardrobe of styles to eliminate “overwearing”, which causes faster degradation of the lycra-based materials.

A research survey of over 1,500 women of all ages and lifestyles shows that fit problems are pervasive with over 65% of women having never benefited from a professional fitting and 65% of all women seeking improvements in comfort when they wear their bras. The following recurrent fit problems obtained from the survey can be resolved with the fit and style recommendations and methods that are disclosed herein: Over 50% report straps that fall down; over 50% need additional support; over 50% are concerned about appearance of back fat; 35% report that underwires hurt; 25% report breast spillage over the cup; 28% report that the straps dig into shoulders and cause grooves from breast weight; 27% report that bra rides up the back; 25% report that they want more breast support and lift of bustline; and 25% report one breast larger than the other.

Additionally, breasts change in shape and size as a result of women's lifestyles, aging, genetics, and medical or physiological change. When the breast shape and size changes, the optimal and desirable bra size and styles change. Over 50% of women report experiencing weight changes, including weight gain and loss. A weight change of approximately 10% body weight generally results in a recommended change in bra size, in terms of cup size and possibly bra band size. Greater than 20% of women report a change in exercise patterns, which again signals the need for a change in styles and size. Greater than 20% of women have experienced pregnancy, which dramatically changes breast firmness, shape and often breast size both during pregnancy and nursing. As a woman returns to her true body weight and size, she is adversely influenced by loss of firmness and her breasts generally become more pendulous. Finally, greater than 25% of all women surveyed report changes in hormone-based medications, including either birth control or hormone therapy to counter menopausal problems. These medications change a woman's size by at least one cup size and can be combined with other medical symptoms of water retention and weight gain.

For at least the reasons described above, the current bra fitting techniques are wholly inadequate. Accordingly, there exists a need for techniques to more accurately and more properly personalize and fit a woman with one or more correspondingly appropriate bra shapes and styles.

### SUMMARY OF THE INVENTION

The invention is a custom bra fitting and style methodology to analyze the size and shape of a woman's breasts and body to provide optimal fit and optimal style. The method includes selecting bras for the woman based on six bra fitting tips, or style tips, of youthful, uplift, coverage, proportionate, centered, and definition.

The custom bra fitting method may further include a determination of the woman's bra wardrobe and bra needs and the selection of bras from the various bra styles including T-Shirt, plunge, classic lace, sexy and convertible to complete the woman's bra wardrobe. In addition, the custom bra fitting method may further include selection of bras with varying bra shapes including demi, semi-demi, balcony and full to round out or supplement the woman's bra wardrobe. The bra fitting method may also involve consideration of a questionnaire filled out by the woman about the comfort, style, and wants or desires of women. For example, the questionnaire may allow the woman to indicate whether she wants style ideas and to improve appearance in clothing; wants to build a bra wardrobe and requests recommendations; wants fashion bras; wants beauty enhancement; desires matching bras and panties for beauty; or wants more romantic styles.

### BRIEF DESCRIPTION OF THE DRAWINGS

The invention is illustrated in the figures of the accompanying drawings which are meant to be exemplary and not limiting, in which like references are intended to refer to like or corresponding parts throughout, and in which:

FIG. 1 illustrates style tip youthful;

FIG. 2 illustrates style tip uplift;

FIG. 3 illustrates style tip coverage;

FIG. 4 illustrates style tip proportionate;

FIG. 5 illustrates style tip centered;

FIG. 6 illustrates style tip definition;

FIGS. 7A, 7B, 7C, and 7D illustrate coverage for bra shapes of demi-cup, semi-demi-cup, balcony and full, respectively; and

FIGS. 8A, 8B, 8C, 8D, and 8E illustrate bra styles including T-Shirt, plunge, classic lace, sexy date and convertible bras, respectively.

An appendix also includes photos, diagrams, and other materials that illustrate application of the style tips for small, medium and large-breasted women and provide additional information.

### DETAILED DESCRIPTION OF THE INVENTION

The custom bra fitting method of this invention is a holistic method of fitting that is an individualized process focused on more than just the right size. It is a holistic method of fitting, which is based upon proper positioning of the bra on the body and achieving support from the bra band that goes around the body and provides 90% of the lift. The correct band width should be based on body frame size. For instance, a woman with a shirt size of 0-2 typically should wear a bra with a 30 inch band size; and a woman with a shirt size of 4-6 typically should wear a bra with a 32 inch band size. The appendix includes a chart that shows the relationship of bra band sizes to ready-to-wear clothing sizes.

A holistic approach also considers the composition of the bra materials that influence the expansion stretch or retraction (or grab) to the body of typical fabrics used in bra manufacture. Once a bra is firm on the body it is more effective to evaluate if the breast is filling or overflowing the cup to adjust up or down a cup size.

The holistic approach takes into consideration the size and shape of the woman and her breasts, the physical activities of the woman, her lifestyle, and the clothing to be worn with the custom-selected bra. Most importantly, the custom bra fitting method of this invention results in a selection of the right styles of bras and the right fit to provide comfort, improved shape and overall body appearance and the types of bras for every wardrobe need.

As stated previously, women have different body shapes and sizes and different breast shapes and sizes. No two women are the same and no two pairs of breasts are the same. Breasts are unique in volume, size and spacing. As such, there is no universally perfect bra for all women. Indeed, two women could wear the exact same bra size and even the same bra, yet the women may be very different in breast shape and distribution.

Bra sizing and style optimization (perfection) can be achieved from a proper customized bra fitting. In a personalized customized fitting, breasts should not be fit into a bra. Rather, a bra should be perfectly fit to a woman's body and should support her shape. Bras define a woman's breasts by shaping them and as such, bras define a woman's figure and impact how she feels about her self-image. Therefore, a proper bra fitting can change a woman's self-image, boost her confidence, and provide a woman with additional bra styles that she can wear both in foundations and ready-to-wear clothing. It can change the self-defeat and limitations a woman has experienced through years of poor fit and body changes. It also has been shown to ultimately influence the way she experiences and perceives her life.

The six bra fitting tips, or style tips, are youthful, uplift, coverage, proportionate, centered, and definition. These fitting tips have not been previously considered in traditional measurement fittings. Implementation of these fitting tips, or style tips, will result in physical benefits including comfort and ultimate style benefits that improve a woman's appearance and most importantly her self-image. After a custom bra fitting according to this invention, women may realize life changing experiences resulting from a proper bra fit and style. Depending on the individual woman's body, attention to the six fitting tips, or style tips, will give the appearance of a young toned body and increase in perceived proportions through height, slimness and a defined shape. Women may fit differently in clothes, feel thinner, attractive and sexy, and may be able to wear bra styles and other clothing styles that they thought were impossible to fit into and wear.

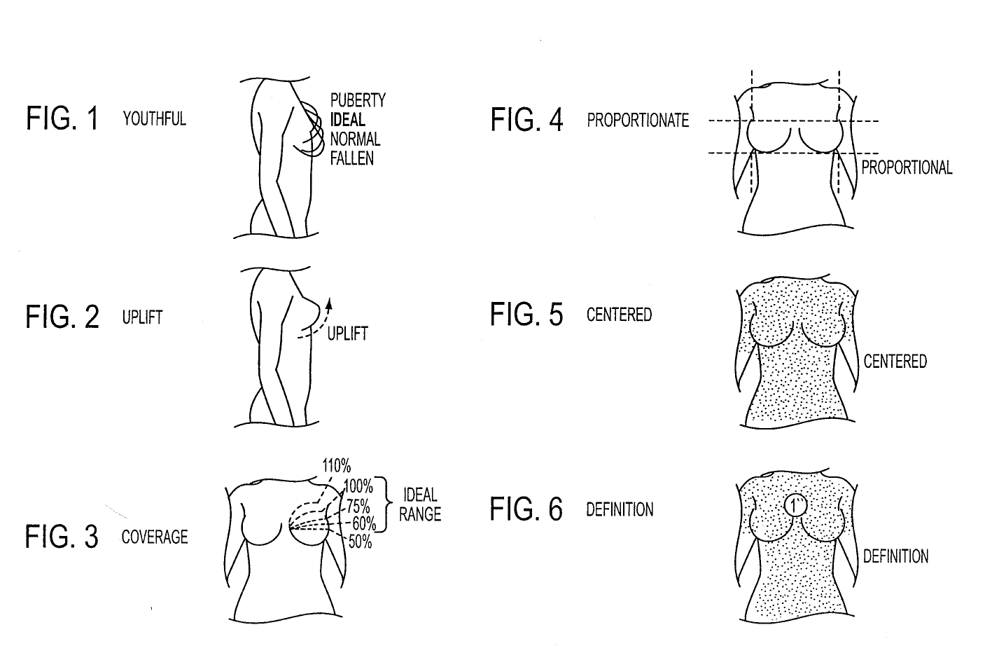

The first fitting tip, or style tip, for consideration in a custom bra fitting is called “youthful.” Implementation of the youthful style tip will result in the ideal breast shape like the shape of breasts of young women. The ideal position of a breast for a youthful appearance is illustrated in FIG. 1. Young breasts have not endured years of breast stress or strain that many women experience over a lifetime due to lack of proper support. Through application of the youthful style tip, upper breast volume will be great enhanced with proper bra fitting and style of bra. It will give a more youthful appearance for women who have experienced a dramatic loss of firmness from common life changes from pregnancy, weight gain or loss, influences of hormone related medications, exercise or genetic influences that result in variations of aging of the skin. As discussed previously, the breast sagging diagram in the appendix illustrates this point.

It is a wide held perception from years of advertising and marketing that women prefer a youthful appearance and desire a firm upper breast shape. Women of all ages want to wear ready-to-wear outerwear clothing with low or wide square neck lines or plunging V-neck lines that often show off upper breast volume. Indeed, many women consider or spend thousands of dollars for plastic surgery to reconstruct the breasts to create a youthful appearance. However, a well styled and fitted bra can achieve the same level of firmness appearance without costly medical procedures. In addition, putting on a bra properly, as explained below and further detailed in the appendix, can also improve upper breast shape.

This desired upper breast volume, which results from the youthful style tip, can be achieved through proper fitting of a bra and selection of a bra that will create a firm, round, natural look for the breasts. For example, a rigid heat formed cup or a contour-lined bra with light soft shaping may assist in this area by making the upper breast shape and volume look natural and firm. This youthful style tip can help a fitter observe and counsel a woman that she can overcome pointy, pendulous, or fallen breast shape problems that women become dissatisfied with as they experience aging. Many women who have considered breast reconstruction surgery have realized such dramatic improvements in “youthfulness” after a custom bra fitting that optimizes fit and style that they no longer felt it necessary to resort to costly or painful surgical procedures.

The second fitting tip, or style tip, “uplift,” is illustrated in FIG. 2. Application of this fitting tip to selection of a bra will result in a bra that lifts from the base of breast for even cup distribution. A bra provides uplift when it supports from the base and the underwire of the bra. The fit, sizing and style selection will also affect the uplift a woman achieves and therefore this recommendation by a fitter can greatly enhance the bra's performance. Many bras are designed poorly with too much stretch in the lower cup (as shown in the two Bali® advertisements in the appendix) or not properly supported with an underband or a firm centerpiece between the breasts (as shown in drawings in the appendix). If a woman has normal to fallen breasts, it is imperative that uplift is considered in the custom fit and bra selection recommendations described herein.

A popular bra style, called minimizers, is intended to make a full busted woman look smaller busted. They do not provide uplift or adequate support of the breast and actually increase the surface area on woman's chest making her look wider and thick though the torso. Uplifting the breast tissue will increase the perceived length of her torso and actually will give the woman the appearance of having lost one full dress size and gained inches in height. It is unhealthy to compress breast tissue, because firmness will be lost.

Seamed bras with a rigid underwire, lined or rigid fabric and seaming in the cup provide the maximum lift and breast support, such as the Prima Donna® Deauville. For increased support, some better designed and quality bras have an underband bridge across the bottom, underneath the entire front of the bra cups (as shown in a drawing in the appendix). When a bra provides the requisite uplift, the whole bra will be stable on the bodice. There will be less pressure on the torso under the breasts, the weight of the breasts will be evenly distributed in weight and volume within the cup, and there will be less breast strain on the breast ligaments. To the contrary, many modern bras are made with stretch materials that will sag and not provide the required support. If the breast sags down, the bra is not stable and the underwire will pull forward and will dig into breast tissue. This is why women object to the underwires in bras despite the fact that they actually provide breast cup definition and breast support. All of these problems are resolved when the style tip of uplift is employed. This style tip includes determining which bra style, as well as the associated bra dimension of cup size and band length/width.

The third fitting tip is “coverage,” illustrated in FIG. 3. Ideally, a bra should cover between 60% and 100% of the breast depending on body frame and cup size. Over 100% coverage is not desirable as the woman is likely wearing too large of a cup size. Too much coverage makes any woman feel fuller busted than she wants to be as well as mature. Bras providing over 100% coverage are not desirable as women associate these bras with looking older. Such bras have been coined “granny bras.” When a woman is wearing too large of a cup size, she lacks definition and breast shape. The appendix includes a Playtex® advertisement that includes a bra that provides too much coverage. This Playtex® bra has been one of the top three selling bras in the United States.

While some women wear bras that cover too much of the breast, others wear bras that do not cover enough. This may result in a breast falling out of a bra as a woman moves. For instance, the Victoria's Secret® advertisement in the appendix pictures a woman with her breasts overflowing the cup. Breast spillage over or under the bra, otherwise known as the double breast effect, is visible under clothing and signals poor fit. This style tip includes determining the coverage dimensions for the different bras relative to the woman, including the woman's physique and dimensional characteristics, as well as the associated bra style.

A woman should consider having bras with a range of coverage in her wardrobe. The ideal is to have bras that reflect varying coverage levels that all offer breast definition, optimize her size and provide options under her clothing to match necklines and surface interest. For instance, it may be desirable for a woman to have an assortment of bra shapes including demi-cup, semi-demi-cup, balcony and full bras in her wardrobe.

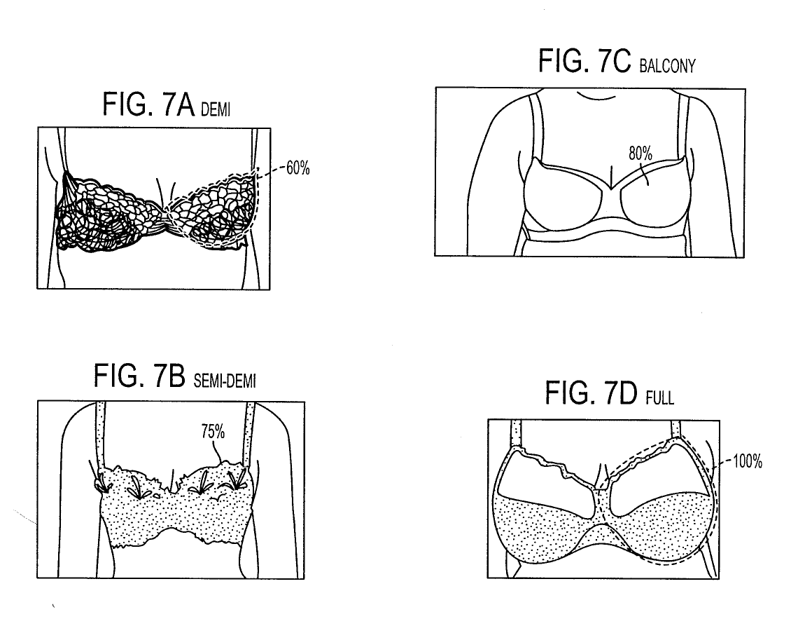

A demi-cup bra, as illustrated in FIG. 7A, covers fifty to seventy five percent of the breast. A demi-cup bra is ideally suited for a woman having a breast size from a small A cup to a generous D cup. They are perceived as being more attractive for a fashionable woman especially when made of sheer lace. However, the primary reason to wear a demi-cup is to define the size and shape. A smaller busted woman wants breast definition afforded by the demi-cup bra shape since she does not have enough breast volume to create her own fullness.

A semi-demi-cup bra, as illustrated in FIG. 7B, offers coverage of sixty to seventy-five percent of the breast tissue. A semi-demi cup bra is ideally suited for an average to fuller bust because the additional coverage provides more support. A semi-demi cup bra generally has transversal seaming that provides support and structure simultaneously. It better encompasses the breast with slightly more cup depth than a demi-cup bra. A woman from a C through F cup can wear a semi-demi cup bra well.

A balcony bra, as illustrated in FIG. 7C, covers seventy to eighty percent of the breast tissue. A balcony bra has seamed support and still provides nice breast definition, and it is appropriate for a DD cup through a GG cup. The unique seaming of a balcony bra shape offers the benefit of three seams for support, stability, excellent lift and cup depth. It is more youthful and attractive than the full cup bra that can become pointy and that some women find offer too much projection.

Finally, a full bra, as illustrated in FIG. 7D, covers ninety to one hundred percent of the breast tissue. A full cup bra is considered a good bra shape for those women who have extra fullness from an FF cup to an HH cup or fuller. More attractive full cup styles are available today than in previous decades as designers have successfully engineered and seamed structural support that is secure with strong and pretty fabrics, sewn finishing details and internal comfort as well as side panels that enable them to be fashionable and well fitting.

Having an assortment of bra shapes ranging from 60% to 100% of coverage will allow a woman to select a perfect bra for every outfit. A woman's bra shape should mirror her clothing neckline. Different bra shapes should be worn with different types of outerwear to enhance breast shape and distribution. For instance, a woman should select a demi-cup or semi-demi cup bra shape to wear with clothing that has a plunging neckline. A demi or semi-demi cup will provide the best inner breast exposure and appearance. As an added benefit, with an assortment of bra shapes in her wardrobe, a woman may now have more clothing options, may be able to wear more attractive clothing styles that were once considered impossible, and may experience a boost in self-confidence.

It should also be noted that as all woman and all breasts are different, some women and breasts may not be shaped for the extremes of 60% or 100% coverage. A woman should be informed that certain coverage may not work for her.

The fourth fitting tip, or style tip, is called “proportionate” and is illustrated in FIG. 4. Application of the fitting tip, or style tip, proportionate will result in a fit that properly supports a woman's breasts and positions them at the right place vertically on her body. To be proportionate, a bustline must be properly balanced between the shoulder and waist, as well as balancing upper bodice with lower torso. A vertically balanced bustline should place the maximum breast volume approximately halfway between a woman's shoulders and elbows. Also, the proper position of a bra should be level across the bodice front and back. This will minimize the appearance of soft tissue on the back. It will also help to encase the soft side tissue, prevent show, and increase comfort. This tip corrects a common problem of hanging too low. A hanging low problem has a negative impact on a woman's appearance and most detrimentally will result in further breast damage over a lifetime.

The fifth fitting tip, or style tip, is “centered,” illustrated in FIG. 5. This fitting tip should be applied in a bra fitting to ensure that the breasts are properly positioned inside the body frame. The breasts should not be positioned so wide that a woman brushes her breasts with her arms with every movement. When the breasts are properly centered within the body frame, a woman will appear thinner. Further, properly centered breasts will improve appearance by adding importance and energy.

The sixth fitting tip, or style tip, is “definition,” illustrated in FIG. 6. For proper breast definition and for the ideal shape, there should be approximately a one inch center space between the breasts. Definition can be provided by a bra that creates perfect separation of the cups, as shown in pictures in the appendix. Small busted women and large busted women benefit equally from definition between breasts on the body. With proper definition, larger-breasted women look smaller and smaller-breasted women look larger. The definition style tip optimizes the breast size on the torso.

Thereby, the present invention includes the determination and selection of an optimized bra option or options for a woman based on the above-noted six style tips. Various techniques may be utilized to determine the six factors, including visual or physical measurements during the fitting exercise. Upon determination of these style tips, the method includes the selection of one or more ideal bras based upon the style tips.

The above-described method may further be implemented in a computing system for performing the bra fitting techniques as described herein. For example, the computing system may perform computation operations in response to executable instructions, such as instructions stored on one or more forms of memory, such as an embedded memory device within the computing system, or in another example the instructions being provided from a portable storage medium readable by the computing device. The method may be implemented wherein the above-described style tips can be electronically computed for determining a bra fitting, such as in one exemplary embodiment having a database of bra styles with corresponding size and fit factors, such that the computing system may be operative to select one or more optional bra for the woman in response to the six style or fitting tips. It is also recognized that computer-implemented embodiments of this methodology may also provide computation resources directed to additional embodiments relating to the fitting as recognized by one having ordinary skill in the art. In one example, additional fitting aspects may relate to the woman's wardrobe selection and bra style selection(s), such as described in further detail below. In another example, questionnaire information, as described in further detail below, may be acquired and/or processed through the computing system to provide additional resources for the bra fitting techniques described herein. In yet another example, the computing system may also provide additional information, e.g. how to put on a bra, how to care for a bra, etc., to the woman to compliment the bra fitting techniques described herein.

It is a further aspect of the custom bra fitting method invention to select bras of various styles to supplement and round out the woman's wardrobe. Many women will wear fewer than two bras even though they own many more. Other women may own several of the exact same bra. However, to have the right bra for the right outfit or the right mood, a woman should consider having some bras that fit into the five bra styles of T-Shirt, plunge, classic lace, sexy and convertible.

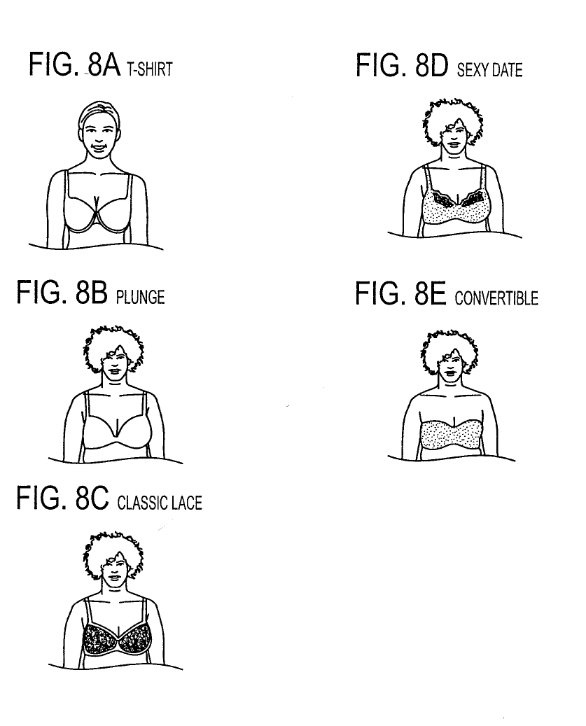

First, a T-Shirt bra, as illustrated in FIG. 8A, provides a smooth natural bust line, and seam-free look under fitted fashions. A T-Shirt bra is generally of skin-toned color and made of a lycra-type fabric with low to no surface interest. T-Shirt bras are perfect to wear under revealing and tight-fitting tops. T-Shirt bras are also ideal for casual wear, such as T-Shirts, tank tops, thick knitwear tops and sweaters. The popularity of T-Shirt bras has resulted in women only owning these types of bras and not knowing what other types of bras would be desirable. Most T-Shirt bras offer a no-show look under clothing, are safe to wear with most clothes, and make up more than 70% of the bras owned today in the United States. The result of this over-dominance is that women are unaware of the options that plunge, lace, sexy bras can play in their look and clothing options and how the other types of bras might influence the way they feel about themselves.

Second, a plunge style bra, as illustrated in FIG. 8B, provides enhanced cleavage and creates great lift for low cut exposure. Importantly, plunge style bras do not compromise the support needed from a bra. Plunge style bras are the perfect under-garment accessory when wearing low-cut necklines and when more lift and enhanced cleavage is desired. A plunge style bra can be a seam-free and smooth nude style for under knits or conforming garments where the wearer is concerned about style show through. A plunge style bra also can be seamed with a vertical seam that runs diagonally across the bra for increased shape and depth in the cup. A plunge style bra is especially perfect for evening wear and special outfits. A lace plunge bra can feature embroidery or lace details and can be worn for a fashionable appearance with V-neck styling when cleavage or inner breast show would be desirable.

Third, a classic lace bra, as illustrated in FIG. 8C, is ideal for breast definition by providing look, lift, fullness and volume. Classic lace bras provide improved shape and better support as the breast volume falls to the seam for support. A classic lace bra is a great “power bra” to wear under a suit and can easily go from day to evening wear. Classic lace bras are perfect when tastefully worn under pretty blouses that are not tight. The fabrications are usually a combination of lycra-based fabrics and embroidery or lace. The fabrics are cut and sewn for varying shape effects with vertical or horizontal seams to add sufficient cup depth and shape. These lace and embellished bras add femininity and fashion and provide emotional benefits as well as shape and wardrobe options.

Fourth, a sexy date bra, as illustrated in FIG. 8D, is made of beautiful fabric and lace. They are characterized by a lower cut shape and wide set straps of straps, which give a more seductive look. Yet, when wearing a sexy date bra, the uplifted bust line still looks natural. Sexy date bras are best with evening attire or special occasion outfits and are perfectly suited for a special night out or romantic evenings. It has been said that every woman needs at least one in her wardrobe for the times when she wants to feel and look sexy. The aesthetic and emotional influence of attractively styled and fashionable lingerie cannot be underestimated. With the advertising and fashion focus on color, fabrications and details, women associate bras with the romantic and beauty benefits. Every woman should have attractively styled fashion bras that enhance her self esteem and beauty whether she is romantically interested, personally involved, or not.

Finally, a convertible style bra, as illustrated in FIG. 8E, provides style benefits because it can be worn with straps, without straps, and with straps that are crisscrossed in the back. They are perfect for demanding necklines and they will provide lift and support without straps. Convertible bras can be worn strapless for tops and dresses that are off the shoulder. Convertible bras can also be adjusted to use only one strap or crisscrossed as needed for halter tops, racer-back tops or one shoulder tops. Convertible bras are often smooth and seam-free and in nude colors so that they are extremely versatile.

For a convertible bra to be worn successfully as a strapless bra, the key is to get sufficient cup depth. If the depth is too little, the woman's bustline will be squashed especially across the top of the cup. Also the bra needs to be firm around the body to give support. If a woman wears a strapless bra that is too large in the back, then the woman will feel like the bra is sliding down her body.

It is a further aspect of the invention to consider a questionnaire completed by the woman prior to a custom bra fitting. The points on the questionnaire include bra fitting issues and problems including, but not limited to, bra straps falling down; band rises up and cuts into shoulder blade; need more bust volume; need more support; not as firm as used to be; underwire digging into breast tissue; finding styles to compliment the woman's bustline; straps dig into shoulder; one breast larger than the other; appearance of back fat; breast tissue comes out underneath the underwire; and soft breast tissue, or pendulous breast.

The questionnaire also provides the opportunity for a woman to share any life changes that may have impacted her breasts and bra sizes. These changes include pregnancy, childbirth, nursing, weight gain or loss, increase in exercise, taking birth control, menopause or hormone replacement medications, breast enhancements and breast reductions. The bra fitting issues and problems selected in a questionnaire will all be addressed during a custom bra fitting in consideration with the six fitting tips.

Another aspect of the custom bra fitting method involves a teaching and learning component. A woman should be advised as to how a bra should be positioned, how firmly the bra should fit to the body, how a level bra band supports the breast, how comfort is achieved through a firm fit (not a loose one), how to adjust a bra, how to overcome back fat, and how to get the best performance and longest life from bras with proper care.

A well-fitted bra should support a woman's body, not vice versa. A bra is the most conforming performance garment that a woman wears. A woman may wear her bra up to 16 to 18 hours a day. Importantly, a bra must be built and fit to meet the demands placed on it.

A firm-fitting bra is the most comfortable as it does not shift on the woman with wear and active lifestyles. It supports and evenly distributes the bust line and results in greater comfort. A woman should fit firmly in loosest hook first so she can tighten the bra as it ages and stretches to retain support over life of the bra. Most people believe that the bra should be hooked on the middle hook to allow for adjustment due to weight loss or gain. However, the bra will relax over time. Because the bra needs to grab and hold the body, it needs to be hooked firmly. Also, most women erroneously rely on the shoulder straps of the bra supporting the bust line. Only 10% of the support should come from the shoulder straps. The bra band should provide 90% of the support.

In a well-fitted bra, a woman should not feel the underwire. Most women experience underwire problems as the result of a too shallow cup or the bra band riding up the back. These ill-fitting bra problems force the underwire to slide forward into the breast tissue, causing weight to impinge on the rib cage, or dig into midriff.

A woman should also be taught how to put on a bra for best support and comfort. First, the woman should bend over at the waist and pull on the bra, front first. Second, the woman should make sure the bra is centered and that volume is evenly distributed. The bra should fit snugly, not tightly, against the rib cage. Third, the woman should fasten the bra. The woman should level the bra back band to be one inch lower than the front. Wearing the band too high decreases support and causes dreaded back fat. The woman should adjust the straps for stability and the straps should not fall down or dig into shoulders. If the straps continue to fall down, then the band is too loose. The woman should ensure that each breast is completely within the bra cup, with the seam over the nipple to prevent show-through. When putting on the bra, the woman should lift her arms up and down to ensure that the bra moves with her and does not shift on the chest. The woman should lightly move her finger across the breast, inside the cup, to smooth the tissue in the cup. If there is a gap between the body and the bra, then the cup is too big. If the breast tissue over flows the bra, then the cups are too shallow. (The appendix includes further information on how to properly put on a bra).

At a custom bra fitting, a woman should be taught that there are ways to improve the life and quality of bras with wear guidelines and care techniques. A bra should be worn two times between washings but one bra should not be worn two days in a row. Bras should be rotated to enable the bras elastic materials to rest and retain their stretch memory. The average woman overwears her comfortable bras and the elastic is shot in a few short months.

Bras should also be cared for properly. They should be washed in a lingerie bag to protect the lace, elastics, and closures. Bras should be washed in the lingerie bag on delicate cycle in cool water with a sensitive lingerie soap that is made from natural cleaners. A harsh laundry detergent will damage the synthetic elastic materials and hot water will shrink the cotton channeling for the underwires and can cause them to pop out of the protective felt. A woman should also let her bras air dry and never put a bra in a dryer because the heat and twisting will cause degradation of the materials. This happens because most standard laundry detergents will leave residue on the bra and the heat from the dryer will cook the residue into the elastic and cause degradation.

Although the six fitting tips, or style tips, are numbered, the numbering has no significance to sequence or application of the six fitting tips, or style tips, in the context of the invention. Similarly, although the various bra styles and bra shapes are numbered, the numbering or sequence has no significance to the invention. The fitting tips, style tips, or the various bra styles and bra shapes may be considered in any order. The numerical references are used for ease of discussion and notation purposes only.

Notably, the figures and examples above are not meant to limit the scope of the present invention to a single embodiment, as other embodiments are possible by way of interchange of some or all of the described or illustrated elements. Moreover, where certain elements of the present invention can be partially or fully implemented using known components, only those portions of such known components that are necessary for an understanding of the present invention are described, and detailed descriptions of other portions of such known components are omitted so as not to obscure the invention. In the present specification, an embodiment showing a singular component should not necessarily be limited to other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the present invention encompasses present and future known equivalents to the known components referred to herein by way of illustration.

The foregoing description of the specific embodiments so fully reveal the general nature of the invention that others can, by applying knowledge within the skill of the relevant art(s) (including the contents of the documents cited and incorporated by reference herein), readily modify and/or adapt for various applications such specific embodiments, without undue experimentation, without departing from the general concept of the present invention. Such adaptations and modifications are therefore intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance presented herein, in combination with the knowledge of one skilled in the relevant art(s).

While various embodiments of the present invention have been described above, it should be understood that they have been presented by way of example, and not limitation. It would be apparent to one skilled in the relevant art(s) that various changes in form and detail could be made therein without departing from the spirit and scope of the invention. Thus, the present invention should not be limited by any of the above-described exemplary embodiments, but should be defined only in accordance with the following claims and their equivalents.

1. A bra fitting method comprising:
analyzing size and shape of a woman's breasts and body;
determining bra fitting tips of youthful, uplift, coverage, proportionate, centered, and definition on the woman; and
selecting at least one bra for the woman based on the bra fitting tips.

2. The bra fitting method of claim 1, further comprising:
determining the woman's bra wardrobe;
selecting at least one bra for the woman from bra styles including T-Shirt, plunge, classic lace, sexy and convertible to complete the woman's bra wardrobe.

3. The bra fitting method of claim 1, further comprising:
determining the woman's bra wardrobe;
selecting at least one bra for the woman from bra shapes including demi, semi-demi, balcony and full.

4. The bra fitting method of claim 1, wherein the bra fitting includes information acquired from a questionnaire completed by the woman.

5. The bra fitting method of claim 1, wherein the bra fitting includes information provided by a professional bra fitter to the woman concerning at least one of bra fit, bra wear, bra care, and bra maintenance.

6. A method for designing bras comprising: determining bra fitting tips of youthful, uplift, coverage, proportionate, centered, and definition, relating to a plurality of women; and designing a bra based on the bra fitting tips.
